(19) United States
(12) Patent Application Publication
(10) Pub. No.: US 2005/0120628 A1
(43) Pub. Date: Jun. 9, 2005

(54) Electrical louver slats shutter

(75) Inventor: Ya'ir Yedidya, Kiryat-Ata (IL)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: ROLLTEC EUROPE LTD., Jerusalem (IL)

(21) Appl. No.: 10/959,821

(22) Filed: Oct. 6, 2004

(30) Foreign Application Priority Data
Nov. 11, 2003 (IL) 158825

(51) Int. Cl. E06B 7/08

(52) U.S. Cl. 49/87.1

(57) ABSTRACT

An electrical louvered shutter has at least one wing, wherein each wing includes a wing framework. A plurality of louver slats are movably pivotally connected to the wing framework and substantially fill the interior area of the wing framework. A tilt rod is connected eccentrically to the louver slats in order to rotate the louver slats from a parallel position in relation to the wing framework to a perpendicular position and vice versa. An electrical motor is installed inside the wing framework, and includes a mechanism that is designated to move the tilt rod. An additional tilt-rod may be connected eccentrically to the louvered shutters, on the other side of each louvered shutter center. The louvered shutter may be installed in a window's frame.

### FIELD OF THE INVENTION

The present invention relates to a functional louvered window shutter having an electrical slats opening and closing.

### BACKGROUND OF THE INVENTION

Window shutters have been used for many years, either for shading purposes, hiding, or both.

There are some types of shutters and some of these types are made of movably louver slats that are installed in a framework and capable to rotate from perpendicular position to horizontal position and versus versa in order to partly or totally shading. These shutters usually have a tilt-rod and with a lever enabling to adjust the angle of the louver slats.

The present invention provides a louver slats shutter, which the rotation of the louver slats is done by a motor for more convenience use.

### SUMMARY OF THE INVENTION

The present invention is an electrical louver slats shutter.

According to the teachings of the present invention there is provided an electrical louvered shutter comprised of at least one wing, wherein each wing includes:
a wing framework;
a plurality of louver slats movably pivotally connected to the framework and substantially filling the interior area of the framework;
a tilt rod connected to the louver slats in order to rotate the louver slats from parallel position in relation to the framework to a perpendicular position and versus versa; and
an electrical motor is installed inside the framework, wherein the motor includes a mechanism that is designated to move the tilt rod.

According to further features in the described preferred embodiment it is provided the electrical louvered shutter, wherein the louvered shutter is installed in a window's frame.

According to another preferred embodiment it is provided the electrical louvered shutter, further includes a switch that commands that motor to rotate clockwise or anticlockwise in order to move the tilt rod that rotates the louver slats from parallel position in relation to the framework—close position—to a perpendicular position—open position—and versus versa.

According to another preferred embodiment it is provided the electrical louvered shutter, wherein the louvered shutter is installed in a window's frame and the switch is installed on the wall beside the window.

According to another preferred embodiment it is provided the electrical louvered shutter, wherein a solenoid is installed instead of the motor.

### BRIEF DESCRIPTION OF THE FIGURES

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the figures:

FIG. 1 illustrates a side view of a shutter's wing, according to the present invention, while the louver slats are closing the shutter.

FIG. 2 illustrates a side view of a shutter's wing, according to the present invention, while the louver slats are in open position.

FIG. 3 illustrates a corner of a wing of the present invention shutter.

### DESCRIPTION OF THE PREFERED EMBODIMENTS

The present invention is a electrical louvered shutter.

The principles and operation of the electrical louvered shutter, according to the present invention, may be better understood with reference to the drawing and the accompanying description.

The present invention is an electrical louvered shutter made of at least one wing, wherein each wing includes a framework with a plurality of louver slats movably and pivotally connected to the framework, which substantially filling the interior area of the framework.

In the preferred embodiment two tilt-rods are connected to the louver slats in order to rotate them from parallel position in relation to the framework to a perpendicular position and versus versa and an electrical motor, with a mechanism that is designated to move the tilt rod up and down, is installed inside the framework. By activating the motor—clockwise or anticlockwise—the tilt-rods are moved the first up and the second down and rotate the louver slats. By this way the angle of the louver slats can be adjust to a desired position.

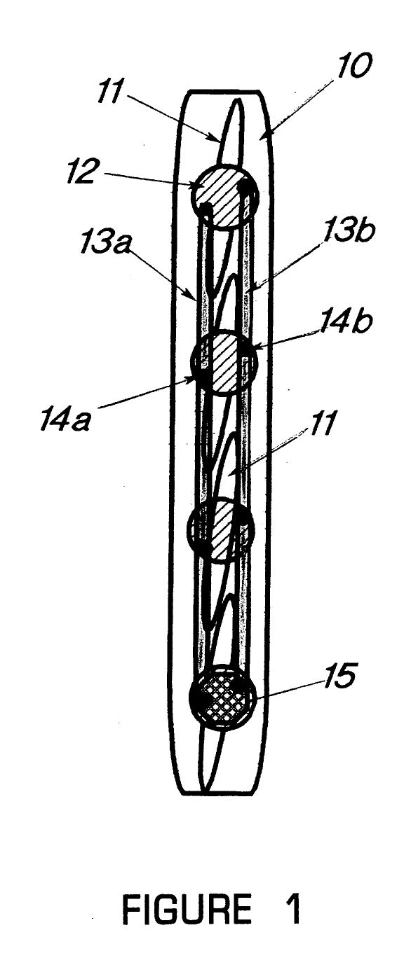

Referring now to the drawing, FIG. 1 illustrates a side view of a shutter's wing, according to the present invention, while the louver slats are closing the shutter. In a framework 10 a plurality of louver slats 11 are pivotally connected and substantially filling the interior area of the framework 10. In this preferred embodiment a plurality of disks 12 are connected one to aside of each louver slat 11. Two tilt-rods 13a&13b are connected to these disks 12 by a movable axis 14a&14b and a motor 15 is connected to one of these disks 12. The first tilt-rod 13a is in a lowered position and the second tilt-rod 13b is in an elevated position.

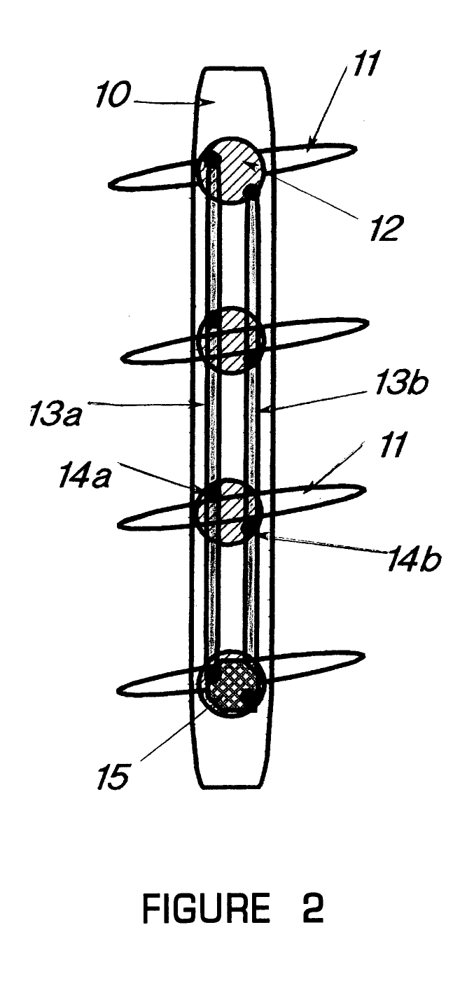

FIG. 2 illustrates a side view of a shutter's wing, according to the present invention, while the shutter is open. When the motor 15 is rotating clockwise, the lower tilt-rod 13a moves up and the upper tilt-rod 13b moves down. This movement rotates the disks 12 that rotate the louvered stats 11 from a perpendicular position to a horizontal position and the shutter in the framework 10 is open.

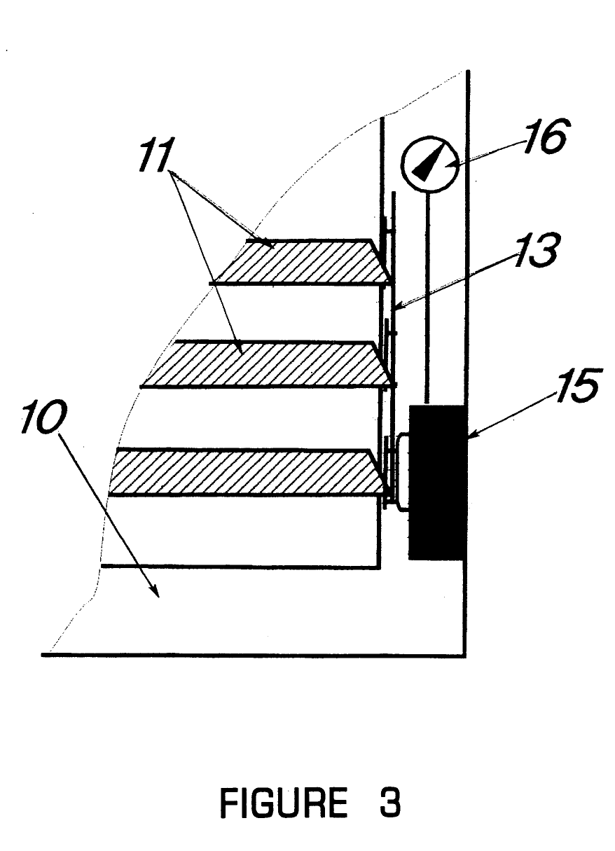

FIG. 3 illustrates a corner of a wing of the present invention shutter. Actually, it is a front view of a shutter's wing, which is formed in a framework 10. The louvered stats 11 are in an open position. By a switch 16 the motor 15 is activated and moves the tilt-rods 13, which rotates the louvered stats 11 to a perpendicular position and close the shutter in the framework 10.

Although the invention has been described in conjunction with specific embodiments thereof, it is evident that many alternatives, modifications and variations will be apparent to those skilled in the art, accordingly, it is intended to embrace all such alternatives, modifications and variations that fall within the spirit and broad scope of the appended claims.

1. An electrical louvered shutter comprised of at least one wing, wherein each wing includes:
a wing framework;
a plurality of louver slats movably pivotally connected to said framework and substantially filling the interior area of said framework;
a tilt rod connected eccentrically to said louver slats in order to rotate said louver slats from parallel position in relation to said framework to a perpendicular position and versus versa; and
an electrical motor is installed inside said framework, wherein said motor includes a mechanism that is designated to move said tilt rod.

2. The electrical louvered shutter of claim 1, further includes an additional tilt-rod connected eccentrically to said louvered shutters, on the other side of each louvered shutter center.

3. The electrical louvered shutter of claim 1, wherein said louvered shutter is installed in a window's frame.

4. The electrical louvered shutter of claim 1, further includes a switch that commands said motor to rotate clockwise or anticlockwise in order to move said tilt rod that rotates said louver slats from parallel position in relation to said framework—close position—to a perpendicular position—open position—and versus versa.

5. The electrical louvered shutter of claim 4, wherein said louvered shutter is installed in a window's frame and said switch is installed on the wall beside said window.

6. The electrical louvered shutter of claim 1, wherein a solenoid is installed instead of said motor.
